(19) United States
(12) Patent Application Publication
(10) Pub. No.: US 2007/0085481 A1
(43) Pub. Date: Apr. 19, 2007

(54) Low-pressure gas discharge lamp having a means for binding oxygen and water

(75) Inventors: Robert Peter Scholl, Rotgen (DE); Rainer Hilbig, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/573,556

(22) PCT Filed: Sep. 24, 2004
(86) PCT No.: PCT/IB04/51850

§ 371 Date: Oct. 18, 2006

(30) Foreign Application Priority Data
Sep. 30, 2003 (EP) 03103614.8

(51) Int. Cl. H01J 61/12; H01J 17/20; H01J 61/20

(52) U.S. Cl. 313/637; 313/640

(57) ABSTRACT

A low-pressure gas discharge lamp is described that comprises, in a gas discharge vessel, one or more inert gases as a buffer gas, an indium halide and means for producing and maintaining a low-pressure gas discharge, in which lamp the indium halide is present as a monohalide and present in addition is a means that binds oxygen and water. The said means should bind oxygen and the oxygen in water more strongly than indium does. This object is satisfactorily achieved by indium, gallium, germanium, boron, molybdenum and/or tungsten.

The invention relates to a low-pressure gas discharge lamp that comprises, in a gas-discharge vessel, one or more inert gases as a buffer gas, an indium halide and means for producing and maintaining a low-pressure gas discharge.

The generation of light in most prior art low-pressure gas discharge lamps is based on the fact of charge carriers, particularly electrons but also ions, being so much accelerated by an electrical field between the electrodes of the lamp that, in the gas filling of the lamp, they excite or ionize the atoms or molecules of the filling by colliding with them. When the atoms of molecules of the gas filling revert to their ground state, a greater or lesser proportion of the energy of excitation is converted into radiation.

Conventional low-pressure gas discharge lamps contain mercury in the gas filling and also have a phosphor coating on the inside of the gas discharge vessel. It is a disadvantage of mercury low-pressure gas discharge lamps that mercury emits radiation primarily in the high-energy but non-visible UV-C range of the electromagnetic spectrum and this radiation has first to be converted by phosphors into visible radiation of substantially lower energy. In the process, the difference in energy is converted into unwanted heat.

However, due to its toxic effect, the mercury in the gas filling is widely objected to nowadays and wherever possible is no longer used in modern-day mass-produced items.

It is already known for the spectrum of low-pressure gas discharge lamps to be acted on by replacing the mercury in the gas filling with other substances. In this way, there are described in German patent applications laid open to public inspection DE 100 44 562, DE 100 44 563, DE 101 28 915 and DE 101 29 464 low-pressure gas discharge lamps that have a gas filling comprising a compound of copper, a compound of indium or a compound of thallium together with an inert gas as a buffer gas. These lamps are notable for the higher radiation yield that they have in the visible range of the electromagnetic spectrum than conventional mercury low-pressure gas discharge lamps. Also, their visual efficiency can be even further improved by incorporating additives and phosphors and by controlling the internal pressure in the lamp and the operating temperature.

Of the metal compounds which have been examined to date for use in low-pressure gas discharge lamps, particular attention has been paid to indium halides. It has been found in this case that a particularly high radiation yield can be obtained when indium monohalides are used, whereas indium trihalides produce only a considerably lower radiation yield in low-pressure gas discharge lamps. The reason for the low radiation yield when indium trihalides are used is thought to be decay into monohalides and halogen in the plasma under equation (1)
InX₃→InX+X₂ (1)
In this equation, X represents the halogens chlorine, bromine and iodine. The presence of the halogen X₂ reduces the radiation efficiency in this case.

Unfortunately, in discharges in which (apart from an inert gas as a buffer gas) only indium monohalide is used or, to be exact, in discharges in which the molar ratio of the indium to the halogen X (X=halogen=Cl, Br or I) is equal to or greater than 1, the inefficient trihalide and the inefficient halogen are formed by reaction with oxygen and/or water. Oxygen and/or water are present in the lamp as contaminants.

The chemical reactions that take place in this case are represented by equations (2) to (5).
4InX+3O₂→2In₂O₃+2X₂ (2)
6InX+3O₂→2In₂O₃+2InX₃ (3)
2InX+3H₂O→In₂O₃+3H₂+X₂ (4)
3InX+3H₂O→In₂O₃+3H₂+InX₃ (5)

What all these reactions have in common is that the indium monohalide that is important to the radiation yield is converted into trihalides of indium or directly into halogens, both of which are inefficient from the point of view of radiation yield.

It was therefore an object of the invention to find a means that, in a gas discharge vessel was capable of preventing the chemical reactions (2) to (5) detailed above in order to ensure a stable and high concentration of indium monohalide.

It was found that this object is achieved by a low-pressure gas discharge lamp that comprises, in a gas discharge vessel, one or more inert gases as a buffer, an indium halide in which the indium halide is present as a monohalide and, in addition, a means that binds oxygen and water.

By virtue of the above addition, the formation of trihalides, and also the formation of halogens that occurs as a result of the conversion of indium monohalide by oxygen and water, are suppressed and in this way low-pressure gas discharge lamps are obtained that show a considerably higher radiation yield.

There are two preconditions that the oxygen-binding and water-binding means to be used in accordance with the invention has to meet: it should bind oxygen more tightly than indium does and it should make a weaker bond with halogen than indium does.

It has been found that these demands are met by indium, gallium, germanium, boron, molybdenum and tungsten. The addition of the said elements suppresses the chemical reactions (2) to (5) detailed above because they bind oxygen more strongly than indium does. On the other hand, the said elements bind the halogen more weakly than indium does and thus ensure that indium halide is present in the gas phase.

The low-pressure gas discharge lamps according to the invention comprise an inert gas from the group helium, neon, argon, krypton and xenon as a buffer gas. The cold pressure of the inert gas is advantageously 1 to 10 mbar and in particular 1.5 to 3 mbar.

In the lamp according to the invention the molecular gas discharge, which emits radiation in the visible and near UV-A range of the electromagnetic spectrum, takes place at low pressure. To convert the UV light into visible light, use is made of phosphors that are applied to the inside and/or outside of the discharge vessel. These phosphors or combinations of phosphors need not be applied to the inside of the gas discharge vessel but may also be applied to its outside, because the radiation produced in the UV-A range is not absorbed by the materials currently used for the discharge vessel. The materials that may be considered as phosphors have to absorb the radiation produced and re-emit it in a suitable wavelength range.

The discharge may be excited capacitively by two external electrodes or one external and one internal electrode and a high-frequency alternating field of e.g. 2.65 MHz, 13.65 MHz, . . . 2.4 Ghz etc.

Electrical excitation with two inner electrodes made of high-melting metals such as tungsten and rhenium is also possible. The internal electrodes may also be provided with an emitter material having a low work function.

Especially preferred is an embodiment of the invention wherein the discharge is excited inductively. In this embodiment the discharge is not excited between two electrodes, but “electrodelss” in a discharge vessel shaped as a closed ring. The energy for exciting the discharge is injected via a magnetic field e.g. by two ferrite core coils.

According to a further embodiment of inductive operation the energy is injected via a high frequency antenna loaded by a separate 2.65 MHz generator into a pea-shaped discharge vessel.

Inductively operated low pressure discharge lamps do not contain any wear parts. Such lamps are especially useful as backlighting of LCD-Displays, in UV-disinfection and UV-curing of resins, as they show extreme longevity.

1. A low-pressure gas discharge lamp that comprises, in a gas-discharge vessel, one or more inert gases as a buffer gas or gases, an indium halide and means for producing and maintaining a low-pressure gas discharge, characterized in that the indium halide is present as a monohalide and present in addition is a means that binds oxygen and water.

2. A low-pressure gas discharge lamp as claimed in claim 1, characterized in that the means that binds oxygen and water binds oxygen and the oxygen in water more strongly, and halogen more weakly, than indium does.

3. A low-pressure gas discharge lamp as claimed in claim 1, characterized in that indium, gallium, germanium, boron, molybdenum and/or tungsten is present as the means that binds oxygen and water.

4. A low-pressure gas discharge lamp as claimed in claim 1, characterized in that it comprises an inert gas from the group helium, neon, argon, krypton and/or xenon as a buffer gas.

5. A low-pressure gas discharge lamp as claimed in claim 1, provided with capacitive means for excitation and maintaining a low pressure discharge comprising at least one external electrode and means for maintaining a high frequency alternating field.

6. A low-pressure gas discharge lamp as claimed in claim 1, provided with electrical means for excitation and maintaining a low pressure discharge comprising at least one internal electrode made from high-melding material.

7. A low-pressure gas discharge lamp as claimed in claim 6, wherein the internal electrode is provided with a material of low work function.

8. A low-pressure gas discharge lamp as claimed in claim 1, provided with inductive means for excitation and maintaining a low pressure discharge selected from the group comprising coils and antennae and means for maintaining a high frequency alternating field.

9. Illumination system, comprising a low pressure discharge lamp according to claim 1.

10. Illumination system according to claim 9, selected from the group of tanning devices, backlighting of LCD-displays, UV-disinfection devices and UV-curing devices.
